(19) United States
(12) Patent Application Publication
(10) Pub. No.: US 2007/0240097 A1
(43) Pub. Date: Oct. 11, 2007

(54) Method For Verifying Rules On Uml Models

(75) Inventors: Arnaud Bailleul, Toulouse (FR); Thierry Le-Saux, Cugnaux (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly-sur-Seine (FR)

(21) Appl. No.: 10/583,137

(22) PCT Filed: Dec. 9, 2004
(86) PCT No.: PCT/EP04/53367

§ 371 Date: Jun. 16, 2006

(30) Foreign Application Priority Data
Dec. 19, 2003 (FR) 03/15023

(51) Int. Cl. G06F 9/44

(52) U.S. Cl. 717/104

(57) ABSTRACT

The method in accordance with the invention is characterized in that after having established a model, the data of the model are structured so as to render them utilizable by the “Model In Action” tool (“MIA”), this tool is made to produce a verification file and a verification report readable by a user is produced on the basis of this file.

### CROSS-REFERENCE TO RELATED APPLICATIONS

The present Application is based on International Application No. PCT/EP2004/053367, filed on Dec. 9, 2004, which in turn corresponds to FR 03/15023 filed on Dec. 19, 2003, and priority is hereby claimed under 35 USC §119 based on these applications. Each of these applications are hereby incorporated by reference in their entirety into the present application.

### BACKGROUND OF THE INVENTION

1) Field of the Invention

The present invention is aimed at a method for verifying rules on UML models.

2) Description of Related Art

To verify compliance with the rules for establishing UML models, no tool currently exists. Some tools, dubbed “Logiscope” and “Rules Checker”, make it possible to verify only the code produced on the basis of the model, and not the specification of the UML model itself.

### SUMMARY OF THE INVENTION

The present invention is aimed at a method which makes it possible to verify the quality of a UML model by verifying compliance with all the modeling rules.

The method of the invention is characterized in that after having established a model, the data of the model are structured so as to render them utilizable by the “Model In Action” tool, this tool is made to produce a verification file and a verification report readable by a user is produced on the basis of this file.

### BRIEF DESCRIPTION OF THE DRAWINGS

The present invention will be better understood on reading the detailed description of a mode of implementation, taken by way of nonlimiting example and illustrated by the appended drawing, in which:

FIG. 1 is a UML diagram of cases of use illustrating the various parties and cases of use of the method of the invention,

FIG. 2 is a block diagram illustrating the architecture of the method of the invention,

FIG. 3 is a view of a verification interface produced according to the method of the invention,

FIG. 4 is a partial view of an exemplary verification report, such as may be produced by the method of the invention, and

FIG. 5 is an exemplary typical extract of the verification report for a rule such as verified by the method of the invention.

### DETAILED DESCRIPTION OF THE INVENTION

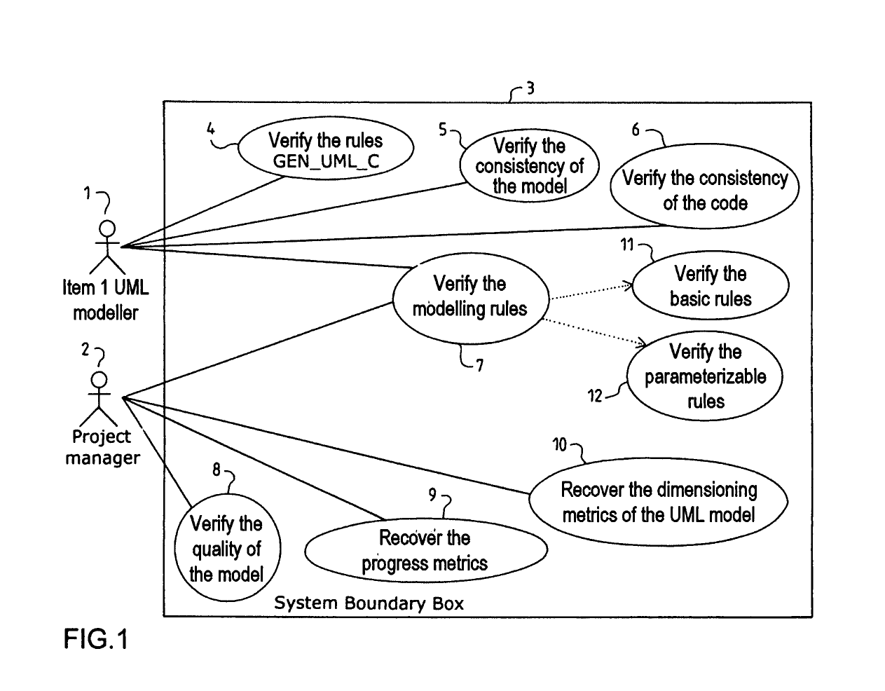

Represented in the diagram of FIG. 1 are the two main types of users apt to use the verification method of the invention, namely a UML modeler (1) and a project leader (2). In a frame (3), delimiting the perimeter of the possibilities of the method of the invention, have been depicted the various actions allowed by this method. These actions are: verification of the code generation rules (4), verification of the consistency of the model (5), verification of the consistency of the code (6), verification of the modeling rules (7), verification of the quality of the model (8), recovery of the modeling progress metrics (9) and recovery of the dimensioning metrics of the UML model (10). The verification of the modeling rules is subdivided into two verifications, namely: the verification of the basic modeling rules (11) and the verification of the parametrizable rules (12).

The supervision of the actions 4 to 6 is generally devolved to the modeler 1, while that of the actions 8 to 10 is generally devolved to the project leader 2, only the action 7 (including its two components 11 and 12) being able to be supervised by the two operators 1 and 2.

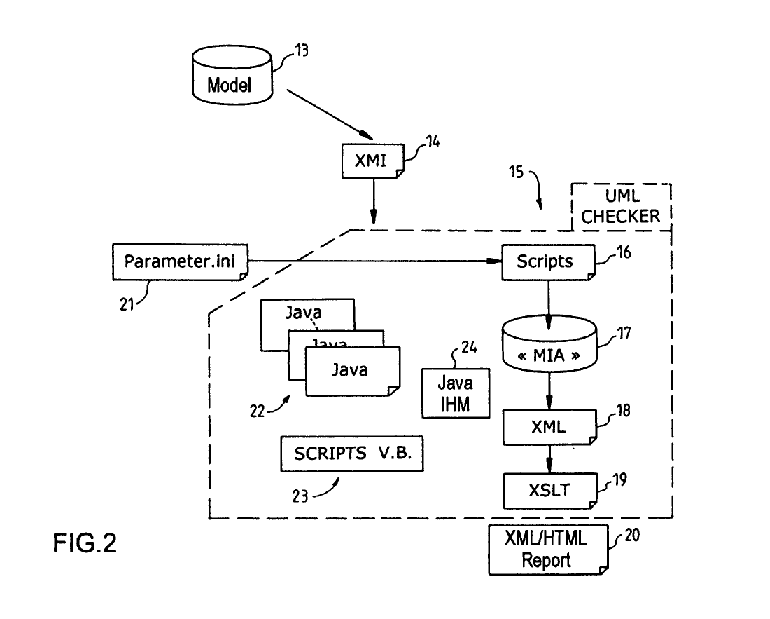

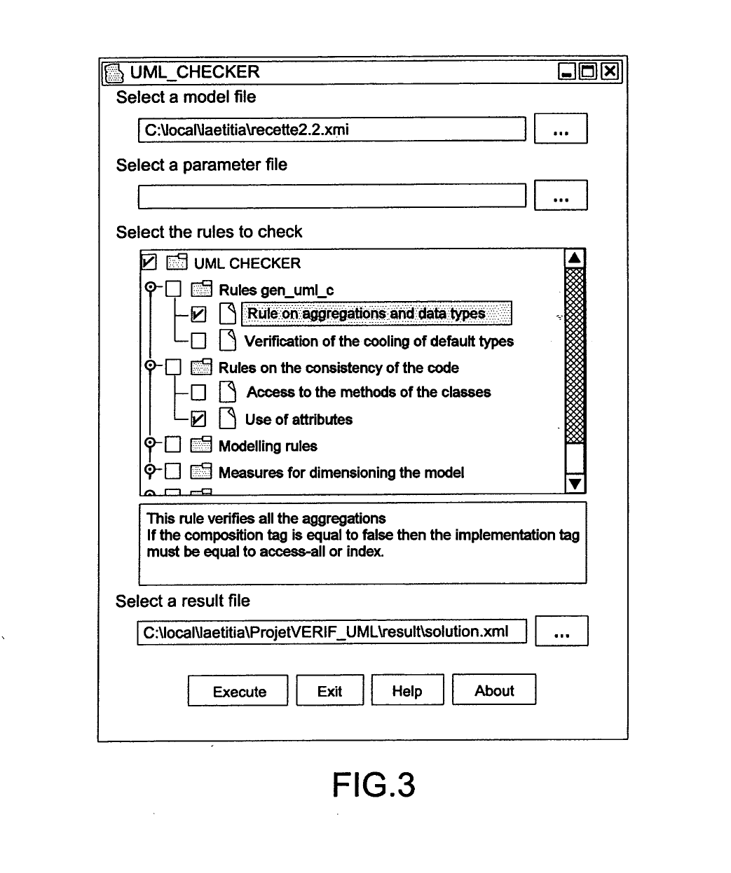

Represented in the diagram of FIG. 2, after the step of modeling of a project (13), for example with the aid of a tool such as “RHAPSODY”, and the exportation of a file in the XMI format (14), are the main steps of the method of the invention, implemented by a tool dubbed “UML CHECKER” (15) and which are: the writing of scripts (16) for an engine for generating files (17), which is here the “Model In Action” tool (more simply dubbed “MIA”, and produced by the company SODIFRANCE). The files produced by the tool (17) are in the XML format (18), then by XSLT conversion (19) transformed into the HTML format so as to obtain a verification report for the model (20) in the HTML format. The “MIA” tool (17) receives a parametrization file for the verification rules (21) (dubbed here “parameter.ini”), constructed by the modeler user. In an advantageous manner, the UML-Checker tool (15) also comprises procedures (22), in the JAVA format for generating graphics (charts) for verifying the quality of the model or the VB scripts (23) making it possible, if appropriate, to process verifications on the graphics of the UML models (impossible via the XMI-14 output). The selection of the verification rules is instructed by way of a java graphics interface (24) implemented in the UML-Checker verification tool (15) and represented in FIG. 3.

In a more detailed manner, the method of the invention proceeds in the following manner:
the user runs the “RHAPSODY” software,
he opens a model from this software,
he selects from this same software the verification tool of the invention (dubbed, as may be seen on the interface represented in FIG. 3, “UML_CHECKER”).

By way of this interface, the user chooses:
the file containing the UML model desired (in the XMI format), in the window “Select a model file”;
the parametrization file, useful for certain rules (“parameter.ini” file referenced (21) in FIG. 2), in the window “Select a parameter file”,
the rules to be verified, in the window “Select the rules to check”
the path and the name of the result file (in the XML format), in the window “Select a result file”.

The parametrization file (parameter.ini) allows the user to choose the parameters to be taken into account for the verification of certain rules. For example, a rule verifies the number of characters of the attributes of a class. If the number of characters of an attribute exceeds the number which is located in the parametrization file, an error is signalled in the verification report.

The user must choose the verification rules that he desires to apply to his model. The rules are exhibited in the form of a tree classing each rule by category, as may be seen in FIG. 3. These categories are those mentioned with reference to FIG. 1 and are detailed below. The selection is done by virtue of boxes to be ticked. Several rules can be selected at the same time. It is also possible to select all the rules of one and the same category by ticking in the tree of the rules the node of the group of rules of this category. When a user selects a rule, its description appears in a window situated just under the selection window “Select the rules to check” of FIG. 3.

The rules that can be selected by the user are of seven different categories (the numerical references corresponding to those of FIG. 1 have been placed between parentheses):
rules for specifying the implementation of the model for the code generator GEN_UML_C (4)
rules on the consistency of the model (for example to avoid the phantom relations that may be induced by poor realization of the UML graphics under RHAPSODY) (5),
rules on the consistency of the code (for example to verify that access to the methods of all the classes is correct) (6),
rules on the modeling (to verify, for example, if the prohibition of multiple heritage is complied with) (7),
calculation of metrics (number of classes abstracted for example) (10),
calculation of progress metrics for the modeling, for the project managers (9),
measurement of the quality of the model (verification of the metrics like the complexity of a class for example) (8).

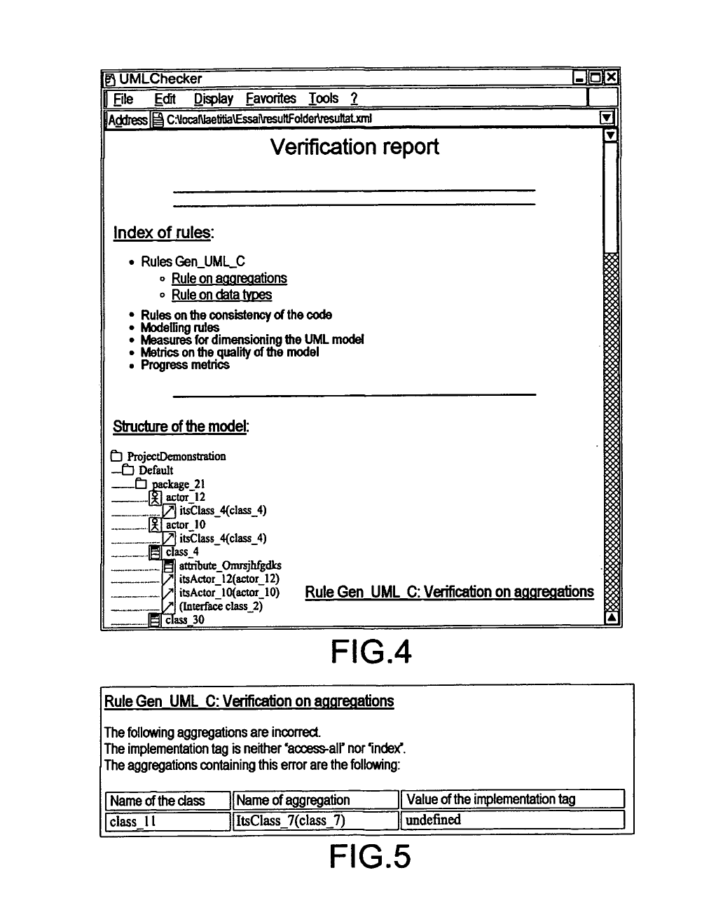

Finally, the user chooses a name of a result file in the XML format. The user can select an already existing file or create a new one. Represented in FIG. 4 is a partial example of such a file, which is dubbed “Verification report” in this figure.

For the verification tool of the invention, the XSLT tool is used to transform the result file, which is in the XML format, into an HTML document. Specifically, this tool makes it possible to transform XML documents into other documents in the XML format or into another appropriate format, such as HTML. Represented in FIGS. 4 and 5 is a partial example of a document in the HTML format that may be produced thus. This document is easily utilizable by users.

The document represented in FIGS. 4 and 5 is composed of three main parts:
the first part (represented at the top of FIG. 4) is the index of the rules which have been verified. In the example of FIG. 4, two rules related to the code generator have been verified: rule on the aggregations and rule on the “DataTypes” (types of data),
the second part (represented at the bottom of FIG. 4) represents the structure of the UML model. It makes it possible to obtain an overall view of the model and to make visual verifications on its structure directly in the report without having to open a UML model editor.
the third part (FIG. 5) constitutes the verification report proper. For each rule, a corresponding paragraph is created. It is possible, from the index of the rules, to directly access the paragraph related to this rule by virtue of hyperlinks. At the end of each rule, a hypertext link makes it possible to return to the top of the page. In the example of FIG. 5, the verification report relates to the code generation rules (“Rule Gen_UML_C”), and the two errors logged pertain to the aggregations. If there is no error for an examined rule, a simple phrase stipulates that there is no error for this rule and replaces the comments paragraph and the table (FIG. 5) which no longer appear in the report.

1. A method for verifying rules on UML models, wherein after having established a model, the data of the model are structured so as to render them utilizable by the “Model In Action” tool MIA, this tool is made to produce a verification file and a verification report readable by a user is produced on the basis of this file.

2. The method as claimed in claim 1, wherein the verified rules are one at least of the rules relating:
to the code generator
to the consistency of the model,
to the consistency of the code,
to the correct modeling,
to the dimensioning measurements,
to the modeling progress measurements,
to the quality of the model.

3. The method as claimed in claim 1, wherein the file of the model, established in the UML format, is exported in the XMI format to the MIA tool.

4. The method as claimed in claim 1, wherein the report file produced by the MIA tool is in the XML format.

5. The method as claimed in claim 4, wherein the file in the XML format produced by the tool is converted into the XSLT format so as to be transformed into a document file of another appropriate format.

6. The method as claimed in claim 2, wherein the file of the model, established in the UML format, is exported in the XMI format to the MIA tool.

7. The method as claimed in 2, wherein the report file produced by the MIA tool is in the XML format.

8. The method as claimed in 3, wherein the report file produced by the MIA tool is in the XML format.
